(19) United States
(12) Patent Application Publication
(10) Pub. No.: US 2023/0124299 A1
(43) Pub. Date: Apr. 20, 2023

(54) METAL/CARBON-DIOXIDE BATTERY AND HYDROGEN PRODUCTION AND CARBON DIOXIDE STORAGE SYSTEM COMPRISING SAME

(71) Applicants: Hyundai Motor Company, Seoul (KR); Kia Corporation, Seoul (KR); Industry-Academic Cooperation Foundation, Yonsei University, Seoul (KR)

(72) Inventors: Yun Su Lee, Uiwang (KR); Ji Hoon Jang, Suwon (KR); Dong Il Lee, Goyang (KR); Yong Sung Jo, Seoul (KR)

(21) Appl. No.: 17/958,595

(22) Filed: Oct. 3, 2022

(30) Foreign Application Priority Data
Oct. 14, 2021 (KR) 10-2021-0136204

(51) Int. Cl. H01M 12/06; H01M 12/02; H01M 4/38; H01M 4/92; H01M 50/489; H01M 50/289; C25B 1/04; C25B 5/00; C25B 9/17; C25B 11/052; C25B 11/065; C25B 11/081; C25B 11/061; C25B 13/02

(52) U.S. Cl. CPC H01M 12/06; H01M 12/02; H01M 4/38; H01M 4/925; H01M 50/489; H01M 50/289; C25B 1/04; C25B 5/00; C25B 9/17; C25B 11/052; C25B 11/065; C25B 11/081; C25B 11/061; C25B 13/02; H01M 2004/027

(57) ABSTRACT

Disclosed are a metal/carbon-dioxide battery and a hydrogen production and carbon dioxide storage system including the same.

### CROSS-REFERENCE TO RELATED APPLICATION

This application claims under 35 U.S.C. § 119(a) the benefit of priority from Korean Patent Application No. 10-2021-0136204, filed on Oct. 14, 2021, the entire contents of which are incorporated herein by reference.

### TECHNICAL FIELD

The present invention relates to a metal/carbon-dioxide battery and a hydrogen production and carbon dioxide storage system including the same.

### BACKGROUND

For the recent development of renewable energy to respond to climate change, thorough research into electrochemical water electrolysis is ongoing. In addition, the importance of technology for capturing, storing and converting carbon dioxide (CO₂) in order to reduce greenhouse gas emissions is increasing.

A zinc/aluminum (Zn/Al)-based aqueous battery system is a very economical metal anode candidate in terms of price and reserves. A zinc/aluminum (Zn/Al)-based aqueous battery system is a system that produces hydrogen and simultaneously captures carbon dioxide in the form of salts such as KHCO3 and the like.

In the related art, a secondary battery has been reported. The secondary battery includes (i) a cathode unit; (ii) an anode unit; and (iii) a connection unit. The cathode unit includes a first aqueous solution accommodated in a first accommodation space and a cathode that is at least partially submerged in the first aqueous solution. The anode unit includes a second aqueous solution that is basic and accommodated in a second accommodation space and a metal anode that is at least partially submerged in the second aqueous solution. The connection unit includes a connection path through which the first accommodation space communicates with the second accommodation space and an ion transfer member having a porous structure installed in the connection path and configured to block movement of the first aqueous solution and the second aqueous solution but to allow movement of ions.

Here, the secondary battery is configured such that, during discharge, carbon dioxide gas is introduced into the first aqueous solution, so hydrogen ions and bicarbonate ions are generated through the reaction between the water in the first aqueous solution and the carbon dioxide gas, and the hydrogen ions are coupled with electrons of the cathode, thereby producing hydrogen gas.

However, the above secondary battery has high cell resistance because the distance between the anode and the cathode is long. When the cell resistance is high, the driving efficiency of the battery is greatly reduced. When the above secondary battery is discharged with a current of about 80 mA, the cell potential is negative; that is, a nonspontaneous reaction occurs. Therefore, it is necessary to develop a battery that is driven spontaneously due to the low cell resistance thereof.

### SUMMARY

In one preferred aspect, provided is a metal/carbon-dioxide battery having greatly increased efficiency due to the low cell resistance thereof.

In one preferred aspect, provided is a metal/carbon-dioxide battery that is driven spontaneously even when the electrolyte of a cathode or an anode is seawater.

The term “metal/carbon-dioxide battery” as used herein refers to a type of an electrochemical cell that uses an anode made from pure metal and an external cathode of ambient air including CO₂. For example, during discharging of a metal/CO₂ electrochemical cell, a reduction reaction occurs in the air (CO₂) cathode while the metal anode is oxidized. Exemplary anode material may include lithium (Li), sodium (Na), potassium (K), zinc (Zn), magnesium (Mg), calcium (Ca), aluminum (Al), iron (Fe) or the like. Preferably, the cathode includes a catalyst (e.g., metal catalyst) and/or support for the catalyst for electrochemical reaction (reduction).

The objects of the present invention are not limited to the foregoing. The objects of the present invention will be able to be clearly understood through the following description and to be realized by the means described in the claims and combinations thereof.

In an aspect, provided is a metal/carbon-dioxide battery including: a first plate including a first electrolyte inlet formed therethrough at a predetermined position thereof and a first electrolyte outlet spaced apart from the first electrolyte inlet by a predetermined distance and formed therethrough, an anode located at a first side of the first plate and including a first communication hole formed therethrough to communicate with the first electrolyte inlet and a second communication hole formed therethrough to communicate with the first electrolyte outlet, a separation membrane located at a first side of the anode, a spacer located between the anode and the separation membrane and configured to support an edge of the anode to form a space between the anode and the separation membrane, a cathode located at a first side of the separation membrane, and a second plate located at a first side of the cathode and including a second electrolyte inlet formed therethrough at a predetermined position thereof and a second electrolyte outlet spaced apart from the second electrolyte inlet by a predetermined distance and formed therethrough.

A “first side” may be directing to opposite side of a “second side”. For example, the first side may refer to (+) direction then the second side may refer to (−) direction.

The first plate may include a first body having a plate shape and a first protrusion formed to protrude and to have a predetermined area near a center of a first surface of the first body, the first electrolyte inlet may be formed in the first protrusion through the first protrusion and the first body, and the first electrolyte outlet may be formed in the first protrusion through the first protrusion and the first body.

The first electrolyte inlet may be formed near an edge of the first protrusion, and the first electrolyte outlet may be formed at a position symmetrical to the first electrolyte inlet based on a center point of the first protrusion.

The metal/carbon-dioxide battery may further include a first gasket fitted on an outer circumferential surface of the first protrusion.

The anode may have an area equal to or larger than an area of the first protrusion, and the anode may include aluminum, zinc, or combinations thereof.

The thickness of the anode may be about 1 mm to 50 mm.

The spacer may have a frame shape having an opening and may support an entire edge of the anode to seal the space.

The thickness of the spacer may be about 1 mm to 10 mm.

The thickness of the separation membrane may be about 25 μm to 250 μm.

The cathode may include one or more selected from the group consisting of carbon paper, carbon fiber, carbon felt, carbon cloth, metal foam, and metal thin film.

The cathode may include a noble metal catalyst loaded on a support.

The second plate may include a second body having a plate shape and a second protrusion formed to protrude and to have an area that is equal to or less than an area of the cathode near a center of a first surface of the second body, the second electrolyte inlet may be formed in the second protrusion through the second protrusion and the second body, the second electrolyte outlet may be formed in the second protrusion through the second protrusion and the second body, and the second plate may further include a flow path formed to be recessed from a surface of the second protrusion, one end of the flow path communicating with the second electrolyte inlet and a remaining end of the flow path communicating with the second electrolyte outlet.

A “first surface” may be directing to opposite surface of a “second surface”. For example, the first surface may face to (+) direction then the second side may face to (−) direction.

The cathode may be in direct contact with the second protrusion.

The second electrolyte inlet may be formed near an edge of the second protrusion, and the second electrolyte outlet may be formed at a position symmetrical to the second electrolyte inlet based on a center point of the second protrusion.

The metal/carbon-dioxide battery may further include a second gasket fitted on an outer circumferential surface of the second protrusion.

The metal/carbon-dioxide battery may further include a conductive wire configured to connect the first plate and the second plate to each other.

The metal/carbon-dioxide battery may be configured such that a plurality of structures including the first plate, the anode, the spacer, the separation membrane, the cathode, and the second plate may be stacked, with an insulator interposed therebetween.

In an aspect, provided is a hydrogen production and carbon dioxide storage system including (i) the metal/carbon-dioxide battery as described herein, which is configured to generate hydrogen using carbon dioxide as a fuel, (ii) a first electrolyte supply unit connected to a first electrolyte inlet of the metal/carbon-dioxide battery and configured to supply a first electrolyte to the metal/carbon-dioxide battery, (iii) a second electrolyte supply unit connected to a second electrolyte inlet of the metal/carbon-dioxide battery and configured to supply a second electrolyte and carbon dioxide to the metal/carbon-dioxide battery, and (iv) a separation unit connected to a second electrolyte outlet of the metal/carbon-dioxide battery and configured to receive a product of the metal/carbon-dioxide battery, separate hydrogen gas from the product, and recover carbon dioxide stored in a salt form.

The first electrolyte and/or the second electrolyte may include an alkaline aqueous solution or seawater.

Other aspects of the invention are disclosed infra.

### BRIEF DESCRIPTION OF THE DRAWINGS

The above and other features of the present invention will now be described in detail with reference to certain exemplary embodiments thereof illustrated in the accompanying drawings, which are given hereinbelow by way of illustration only, and thus are not limitative of the present invention, and wherein:

FIG. 1 shows a hydrogen production and carbon dioxide storage system according to an exemplary embodiment of the present invention;

FIG. 2 shows an exploded perspective view illustrating a metal/carbon-dioxide battery according to an exemplary embodiment of the present invention;

FIG. 3 shows a cross-sectional view illustrating the metal/carbon-dioxide battery according to an exemplary embodiment of the present invention;

FIG. 4 shows a plan view illustrating a first surface of the first plate;

FIG. 5 shows a plan view showing the anode;

FIG. 6 shows a plan view illustrating a first surface of the second plate;

FIG. 7 shows a battery stack in which a plurality of metal-carbon dioxide batteries is stacked according to an exemplary embodiment of the present invention;

FIG. 8A shows the results of measurement of cell resistance by driving the batteries in Example and Comparative Example;

FIG. 8B shows the results of measurement of cell potential by driving the batteries according to Example and Comparative Example;

FIG. 8C shows a 50 mA discharge graph of the batteries in Example and Comparative Example;

FIG. 9 shows the results of measurement of cell resistance at different thicknesses of the spacer in the battery according to an embodiment;

FIG. 10A shows the results of measurement of cell resistance of the battery of Example and the battery using seawater; and

FIG. 10B shows a discharge graph of the battery using seawater.

### DETAILED DESCRIPTION

The above and other objects, features and advantages of the present invention will be more clearly understood from the following preferred embodiments taken in conjunction with the accompanying drawings. However, the present invention is not limited to the embodiments disclosed herein, and may be modified into different forms. These embodiments are provided to thoroughly explain the invention and to sufficiently transfer the spirit of the present invention to those skilled in the art.

Throughout the drawings, the same reference numerals will refer to the same or like elements. For the sake of clarity of the present invention, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present invention. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

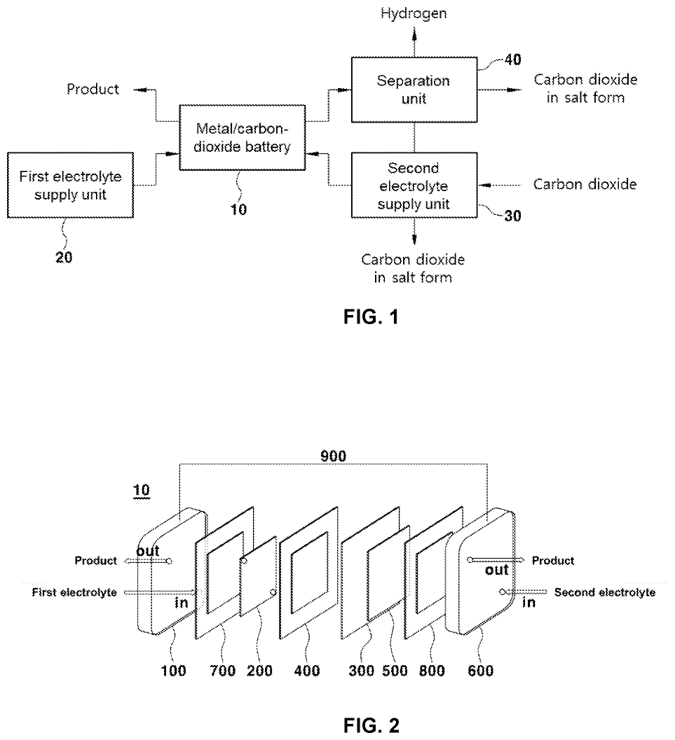

FIG. 1 shows a hydrogen production and carbon dioxide storage system according to an exemplary embodiment of the present invention. For example, the system may include a metal/carbon-dioxide battery 10, a first electrolyte supply unit 20 connected to the metal/carbon-dioxide battery 10 and configured to supply a first electrolyte, a second electrolyte supply unit 30 connected to the metal/carbon-dioxide battery 10 and configured to supply a second electrolyte and carbon dioxide, and a separation unit 40 connected to the metal/carbon-dioxide battery 10 and configured to receive a product of the metal/carbon-dioxide battery and separate and recover hydrogen gas and carbon dioxide stored in a salt form from the product.

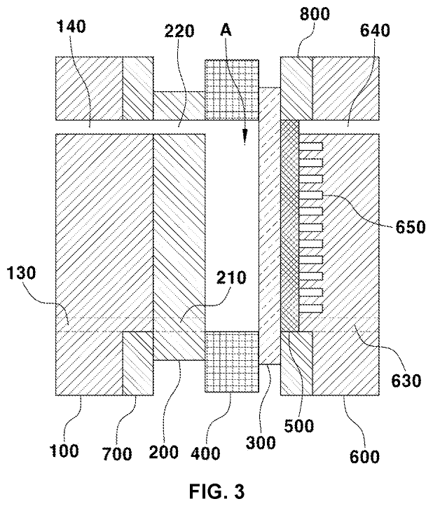

FIG. 2 shows an exploded perspective view illustrating the metal/carbon-dioxide battery 10. FIG. 3 shows a cross-sectional view illustrating the metal/carbon-dioxide battery 10. For example, the metal/carbon-dioxide battery 10 may be configured such that a first plate 100, a first gasket 700, an anode 200, a spacer 400, a separation membrane 300, a cathode 500, a second gasket 800, and a second plate 600 are stacked and the first plate 100 and the second plate 600 are connected to each other using a conductive wire 900.

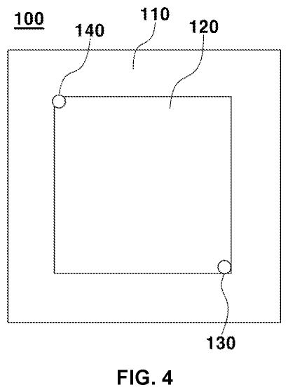

FIG. 4 shows a plan view illustrating a first surface of the first plate 100. The first plate 100 may be provided for current collection, and may be conductive. Accordingly, electrons generated in an oxidation reaction at the anode 200 may move to the second plate 600 through the first plate 100 and the conductive wire 900.

The first plate 100 may include a first body having a plate shape 110, a first protrusion 120 formed to protrude and to have a predetermined area near the center of a first surface of the first body 110, a first electrolyte inlet 130 formed in the first protrusion 120 through the first protrusion 120 and the first body 110, and a first electrolyte outlet 140 spaced apart from the first electrolyte inlet 130 by a predetermined distance and formed in the first protrusion 120 through the first protrusion 120 and the first body 110.

The first electrolyte inlet 130 may be formed near the edge of the first protrusion 120, and the first electrolyte outlet 140 may be formed at a position symmetrical to the first electrolyte inlet 130 based on the center point of the first protrusion 120.

The first gasket 700 serves to prevent a short circuit of the battery. The first gasket 700 may have a frame shape having an opening, and may be fitted on the outer circumferential surface of the first protrusion 120. The thickness of the first gasket 700 may be the same as the height to which the first protrusion 120 protrudes.

The first gasket 700 may be made of a material that is unbreakable and chemically stable. For example, the first gasket 700 may be made of a fluororesin such as Teflon, etc.

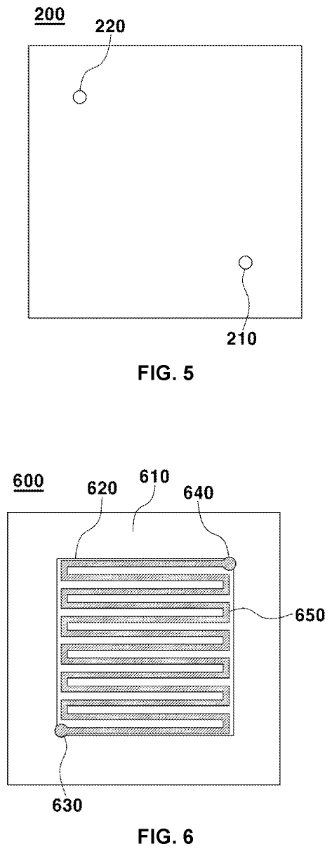

FIG. 5 shows a plan view illustrating the anode 200. The anode 200, which is an electrode made of a metal material, may include aluminum (Al), zinc (Zn), or combinations thereof.

The shape of the anode 200 is not particularly limited, but may have an area that is equal to or larger than that of the first protrusion 120.

The anode 200 may include a first communication hole 210 formed therethrough to communicate with the first electrolyte inlet 130 and a second communication hole 220 formed therethrough to communicate with the first electrolyte outlet 140.

The anode 200 may be in direct contact with the first protrusion 120. Since the first protrusion 120 is conductive, the electrons generated through an oxidation reaction at the anode 200 may move through the first protrusion 120. Particularly, the metal/carbon-dioxide battery according to an exemplary embodiment of the present invention may have a structure in which electrons are able to move even without an additional constituent such as a tab or the like. The anode 200 may have a thickness of about 1 mm to 50 mm.

The spacer 400 may be interposed between the anode 200 and the separation membrane 300 and may be configured to support the edge of the anode 200 to form a space A between the anode 200 and the separation membrane 300.

The spacer 400 may have a frame shape having an opening, and may seal the space A by supporting the entire edge of the anode 200. Particularly, the spacer 400 allows the space A to be connected only to the first communication hole 210 and the second communication hole 220. Accordingly, the first electrolyte is supplied to the space A through the first communication hole 210, the reaction at the anode 200 occurs, and the reaction product or the like is discharged through the second communication hole 220.

The spacer 400 may have a thickness of about 1 mm to 10 mm. When the thickness of the spacer 400 is less than about 1 mm, driving of the battery may become problematic because the first electrolyte does not flow. On the other hand, when the thickness of the spacer 400 is greater than about 10 mm, cell resistance may increase and thus the efficiency of the battery may decrease.

The spacer 400 may be made of a material having superior chemical resistance, such as rubber, resin, silicone, metal, etc.

The separation membrane 300 may have a porous structure, allowing movement of cations between the anode 200 and the cathode 500 but blocking the movement of the electrolyte.

The separation membrane 300 may include a cation conductive resin. For example, the separation membrane 300 may include a perfluorosulfonic-acid-based resin such as Nafion, etc.

The thickness of the separation membrane 300 may be about 25 μm to 250 μm.

The cathode 500 may include one or more selected from the group consisting of carbon paper, carbon fiber, carbon felt, carbon cloth, metal foam, and metal thin film. Alternatively, the cathode 500 may include a catalyst. The catalyst may include a noble metal catalyst such as platinum (Pt) or the like supported on a support.

FIG. 6 shows a plan view illustrating a first surface of the second plate 600. The second plate 600 is provided for current collection.

The second plate 600 may include a second body having a plate shape 610, a second protrusion 620 formed to protrude and to have a predetermined area near the center of a first surface of the second body 610, a second electrolyte inlet 630 formed in the second protrusion 620 through the second protrusion 620 and the second body 610, a second electrolyte outlet 640 spaced apart from the second electrolyte inlet 630 by a predetermined distance and formed in the second protrusion 620 through the second protrusion 620 and the second body 610, and a flow path 650, one end of which communicates with the second electrolyte inlet 630 and the remaining end of which communicates with the second electrolyte outlet 640.

The second plate 600 may be provided for current collection, and may be conductive. Accordingly, the second plate 600 may receive electrons that have moved through the conductive wire 900 and may transfer the electrons to the cathode 500 to be described later. The metal/carbon-dioxide battery according to an exemplary embodiment of the present invention may have a structure in which electrons are able to move even without an additional constituent such as a tab or the like. The second electrolyte inlet 630 may be formed near the edge of the second protrusion 620, and the second electrolyte outlet 640 may be formed at a position symmetrical to the second electrolyte inlet 630 based on the center point of the second protrusion 620.

The cathode 500 may be in direct contact with the second protrusion 620.

The second electrolyte introduced through the second electrolyte inlet 630 may move to the second electrolyte outlet 640 through the flow path 650, during which time the second electrolyte may be provided to the cathode 500. A metal mesh or foam may be provided between the cathode 500 and the second protrusion 620 in order to diffuse the second electrolyte.

The flow path 650 may be formed to be recessed to a predetermined depth from the surface of the second protrusion 620. The shape of the flow path 650 is not particularly limited, and may be formed in a zigzag shape, as shown in FIG. 6.

The second gasket 800 serves to prevent a short circuit of the battery. The second gasket 800 may have a frame shape having an opening, and may be fitted on the outer circumferential surface of the second protrusion 620.

The second gasket 800 may include a material that is unbreakable and chemically stable. For example, the second gasket 700 may include a fluororesin such as Teflon, etc.

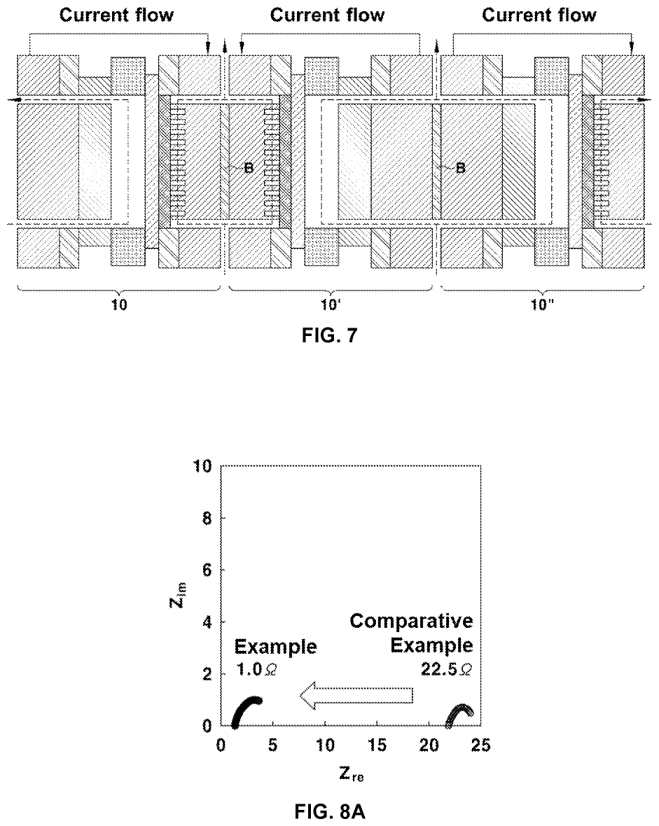

FIG. 7 shows a battery stack in which a plurality of batteries 10′, 10″, 10′″ each including a first plate 100, a first gasket 700, an anode 200, a spacer 400, a separation membrane 300, a cathode 500, a second gasket 800, and a second plate 600 is stacked, with an insulator B interposed therebetween. The dotted-line arrow in FIG. 7 indicates the movement of the electrolyte.

Particularly, adjacent batteries 10′, 10″, and 10′″ may be stacked with an insulator B interposed therebetween, and the electrolyte flows in and out through a gap formed by the insulator B. The adjacent batteries 10′, 10″, and 10′″ may share the electrolyte inlet and the electrolyte outlet.

Hereinafter, driving of the hydrogen production and carbon dioxide storage system will be described in detail.

The first electrolyte supply unit 20 may be configured to supply a first electrolyte to the metal/carbon-dioxide battery 10 through the first electrolyte inlet 130.

The first electrolyte may include an alkaline aqueous solution or seawater. The first electrolyte may include 6M KOH.

The first electrolyte is introduced into the space A between the anode 200 and the separation membrane 300 through the first electrolyte inlet 130 and the first communication hole 210.

When the anode 200 comes into contact with the first electrolyte, the anode 200 is ionized, thus generating electrons. The electrons move to the cathode 500 through the second plate 600 using the conductive wire 900.

Potassium ions (K⁺), which are cations generated in the process of ionization of the anode 200, move to the cathode 500 through the separation membrane 300.

The second electrolyte supply unit 30 is configured to supply a second electrolyte and carbon dioxide to the metal/carbon-dioxide battery 10 through the second electrolyte inlet 630. The system may further include a carbon dioxide supply unit configured to supply carbon dioxide to the second electrolyte supply unit 30.

The second electrolyte may include an alkaline aqueous solution or seawater. The second electrolyte may include 3M KHCO3.

The second electrolyte and carbon dioxide are supplied to the cathode 500 through the second electrolyte inlet 630. At the cathode 500, the chemical elution reaction of carbon dioxide occurs as follows.

CO²(g)+H₂O(l)→H₂CO₃(g)→H⁺(aq)+HCO₃⁻(aq)

Thereafter, at the cathode 500, the hydrogen production reaction occurs as follows.

2H⁺(aq)+2e⁻→H₂(g)

In addition, at the cathode 500, carbon dioxide is stored in the form of a salt as follows.

HCO₃⁻(aq)+K+(aq)→KHCO₃(g)

Here, H₂ and KHCO₃ are discharged to the outside of the battery through the second electrolyte outlet 640 together with the second electrolyte.

The separation unit 40 may receive the discharged materials and may separate hydrogen therefrom. To this end, the separation unit 40 may include a gas-liquid separator. Also, the separation unit 40 may include a filter to recover KHCO³ from the liquid component.

The separation unit 40 may supply the second electrolyte again to the second electrolyte supply unit 30. The second electrolyte supply unit 30 may include a filtration member such as a filter or the like in order to recover unfiltered KHCO³ from the second electrolyte supplied from the separation unit 40.

A better understanding of the present invention may be obtained through the following examples. These examples are merely set forth to illustrate the present invention, and are not to be construed as limiting the present invention.

### EXAMPLE

A metal/carbon-dioxide battery having a stack structure as illustrated in FIGS. 2 and 3 was prepared. The anode included zinc and the cathode included a platinum catalyst (Pt/C) supported on a carbon support. The first electrolyte was 6M KOH and the second electrolyte was 3M KHCO₃. A spacer having a thickness of about 5 mm was used.

### Comparative Example

A fuel cell was prepared.

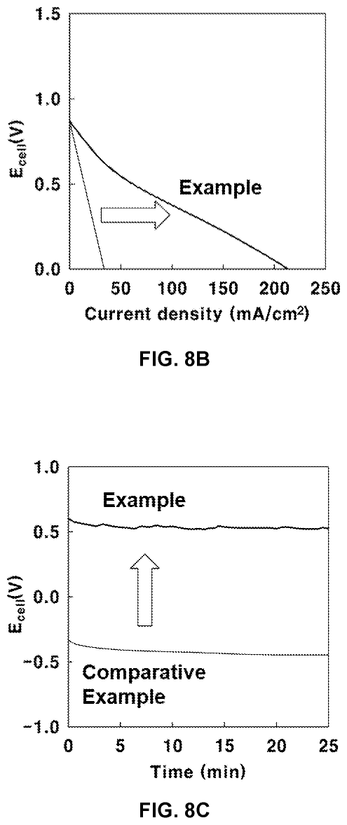

Cell resistance was measured by driving the batteries according to the Example and Comparative Example. The results thereof are shown in FIG. 8A. The cell resistance of Example was about 1.0Ω, and the cell resistance of Comparative Example was about 22.5Ω, from which it can be found that the cell resistance of Example was greatly reduced compared to Comparative Example.

Cell potential was measured by driving the batteries according to Example and Comparative Example. The results thereof are shown in FIG. 8B. Particularly, the battery according to Example was greatly increased in the current density at the point where the cell potential (Ecell) became 0 with a decrease in the cell resistance compared to that of Comparative Example.

FIG. 8C shows a 50 mA discharge graph of the batteries in Example and Comparative Example. The battery in Example exhibited greatly decreased cell resistance, so the cell potential was positive upon 50 mA discharge, indicating that a spontaneous battery reaction occurred.

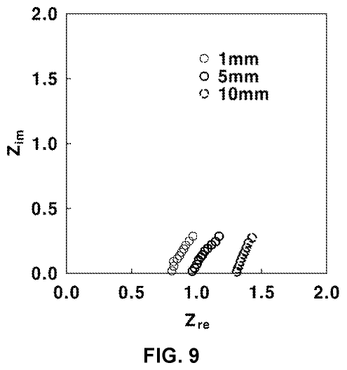

Meanwhile, in order to evaluate the effect of the size of the space between the cathode and the separation membrane in the metal/carbon-dioxide battery according to an exemplary embodiment of the present invention, respective batteries were prepared by adjusting the thickness of the spacer to 1 mm, 5 mm, and 10 mm. Each battery was driven and cell resistance was measured. The results thereof are shown in FIG. 9. When the thickness of the spacer was 1 mm to 10 mm, the cell resistance was very low compared to Comparative Example. Moreover, it was possible to optimize cell resistance by adjusting the thickness of the spacer, that is, the size of the space between the cathode and the separation membrane.

In addition, a metal/carbon-dioxide battery was prepared in the same manner as in Example, with the exception that the first electrolyte was replaced with seawater (0.6M NaCl), after which the battery was driven.

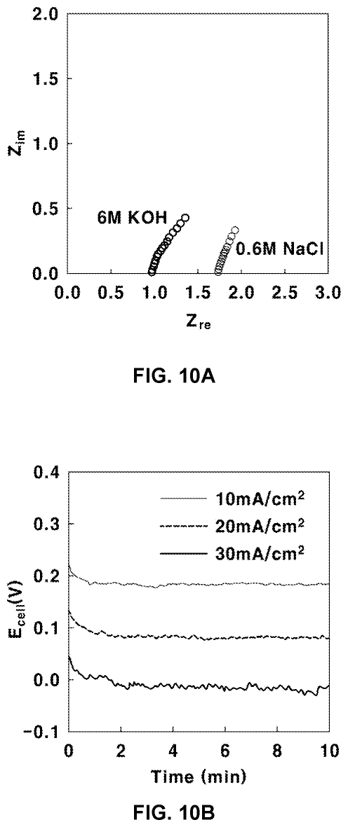

FIG. 10A shows the results of measurement of cell resistance of the battery of Example and the battery using seawater. Particularly, the metal/carbon-dioxide battery according to an exemplary embodiment of the present invention exhibited substantially reduced cell resistance even when seawater was used as the first electrolyte, compared to Comparative Example.

FIG. 10B shows a discharge graph of the battery using seawater. Particularly, the metal/carbon-dioxide battery according to an exemplary embodiment of the present invention was spontaneously driven during discharge even when seawater was used as the first electrolyte.

According to various exemplary embodiments of the present invention, the metal/carbon-dioxide battery having very high efficiency may be obtained due to the low cell resistance thereof.

According to various exemplary embodiments of the present invention the metal/carbon-dioxide battery that is driven spontaneously may be obtained even when the electrolyte of the cathode or the anode is seawater.

The effects of the present invention are not limited to the above-mentioned effects. It should be understood that the effects of the present invention include all effects that can be inferred from the description of the present invention.

As described hereinbefore, the present invention has been described in detail with respect to test examples and embodiments. However, the scope of the present invention is not limited to the aforementioned test examples and examples, and various modifications and improved modes of the present invention using the basic concept of the present invention defined in the accompanying claims are also incorporated in the scope of the present invention.

What is claimed is:

1. A metal/carbon-dioxide battery, comprising:
a first plate comprising a first electrolyte inlet formed therethrough at a predetermined position thereof and a first electrolyte outlet spaced apart from the first electrolyte inlet by a predetermined distance and formed therethrough;
an anode located at a first side of the first plate and comprising a first communication hole formed therethrough to communicate with the first electrolyte inlet and a second communication hole formed therethrough to communicate with the first electrolyte outlet;
a separation membrane located at a first side of the anode;
a spacer located between the anode and the separation membrane and configured to support an edge of the anode to form a space between the anode and the separation membrane;
a cathode located at a first side of the separation membrane; and
a second plate located at a first side of the cathode and comprising a second electrolyte inlet formed therethrough at a predetermined position thereof and a second electrolyte outlet spaced apart from the second electrolyte inlet by a predetermined distance and formed therethrough.

2. The metal/carbon-dioxide battery of claim 1, wherein:
the first plate comprises a first body having a plate shape and a first protrusion formed to protrude and to have a predetermined area near a center of a first surface of the first body,
the first electrolyte inlet is formed in the first protrusion through the first protrusion and the first body, and
the first electrolyte outlet is formed in the first protrusion through the first protrusion and the first body.

3. The metal/carbon-dioxide battery of claim 2, wherein the first electrolyte inlet is formed near an edge of the first protrusion, and the first electrolyte outlet is formed at a position symmetrical to the first electrolyte inlet relative to a center point of the first protrusion.

4. The metal/carbon-dioxide battery of claim 2, further comprising a first gasket fitted on an outer circumferential surface of the first protrusion.

5. The metal/carbon-dioxide battery of claim 2, wherein:
the anode has an area equal to or larger than an area of the first protrusion, and
the anode comprises aluminum, zinc, or combinations thereof.

6. The metal/carbon-dioxide battery of claim 1, wherein a thickness of the anode is about 1 mm to 50 mm.

7. The metal/carbon-dioxide battery of claim 1, wherein the spacer has a frame shape having an opening and supports an entire edge of the anode to seal the space.

8. The metal/carbon-dioxide battery of claim 1, wherein a thickness of the spacer is about 1 mm to 10 mm.

9. The metal/carbon-dioxide battery of claim 1, wherein a thickness of the separation membrane is about 25 μm to 250 μm.

10. The metal/carbon-dioxide battery of claim 1, wherein the cathode comprises one or more selected from the group consisting of carbon paper, carbon fiber, carbon felt, carbon cloth, metal foam, and metal thin film.

11. The metal/carbon-dioxide battery of claim 1, wherein the cathode comprises a noble metal catalyst loaded on a support.

12. The metal/carbon-dioxide battery of claim 1, wherein:
the second plate comprises a second body having a plate shape and a second protrusion formed to protrude and to have an area that is equal to or less than an area of the cathode near a center of a first surface of the second body,
the second electrolyte inlet is formed in the second protrusion through the second protrusion and the second body,
the second electrolyte outlet is formed in the second protrusion through the second protrusion and the second body, and
the second plate further comprises a flow path formed to be recessed from a surface of the second protrusion, one end of the flow path communicating with the second electrolyte inlet and a remaining end of the flow path communicating with the second electrolyte outlet.

13. The metal/carbon-dioxide battery of claim 1, wherein the cathode is in direct contact with the second protrusion.

14. The metal/carbon-dioxide battery of claim 12, wherein the second electrolyte inlet is formed near an edge of the second protrusion, and the second electrolyte outlet is formed at a position symmetrical to the second electrolyte inlet relative to a center point of the second protrusion.

15. The metal/carbon-dioxide battery of claim 12, further comprising a second gasket fitted on an outer circumferential surface of the second protrusion.

16. The metal/carbon-dioxide battery of claim 1, further comprising a conductive wire configured to connect the first plate and the second plate to each other.

17. The metal/carbon-dioxide battery of claim 1, wherein a plurality of structures comprising the first plate, the anode, the spacer, the separation membrane, the cathode, and the second plate are stacked, with an insulator interposed between each pair of the plurality of structures as stacked.

18. A hydrogen production and carbon dioxide storage system, comprising:
the metal/carbon-dioxide battery of claim 1, configured to generate hydrogen using carbon dioxide as a fuel;
a first electrolyte supply unit connected to a first electrolyte inlet of the metal/carbon-dioxide battery and configured to supply a first electrolyte to the metal/carbon-dioxide battery;
a second electrolyte supply unit connected to a second electrolyte inlet of the metal/carbon-dioxide battery and configured to supply a second electrolyte and carbon dioxide to the metal/carbon-dioxide battery; and
a separation unit connected to a second electrolyte outlet of the metal/carbon-dioxide battery and configured to receive a product of the metal/carbon-dioxide battery, separate hydrogen gas from the product, and recover carbon dioxide stored in a salt form.

19. The hydrogen production and carbon dioxide storage system of claim 18, wherein the first electrolyte comprises an alkaline aqueous solution or seawater.

20. The hydrogen production and carbon dioxide storage system of claim 18, wherein the second electrolyte comprises an alkaline aqueous solution or seawater.
